(19) United States
(12) Patent Application Publication
(10) Pub. No.: US 2003/0037678 A1
(43) Pub. Date: Feb. 27, 2003

(54) Wet exhaust processing system

(76) Inventors: Bobby J. Payne, Palm Harbor, FL (US); Timothy Cleveland, New Port Richey, FL (US)

Correspondence Address: HAROLD D. SHALL, 1101 BELCHER RD. SOUTH; SUITE B, LARGO, FL, 33771, US

(21) Appl. No.: 09/934,623

(22) Filed: Aug. 22, 2001

(51) Int. Cl. B01D 47/02

(52) U.S. Cl. 96/245; 96/351; 96/361

(57) ABSTRACT

A wet exhaust processing system including an exhaust separator having a lower water containing portion and a wet exhaust inlet and a separated exhaust outlet above the water. An overflow pipe controls the upper lever of the water in the separator and a pump connected to the lower portion pumps the water therefrom to a filtering device. A sensing and control arrangement controls the operation of the pump and thereby the level of the water in the lower portion

### BACKGROUND OF THE INVENTION

1) Field of the Invention

This invention relates to wet exhaust processing systems for the exhaust from diesel engines generally and more specifically to such a system which insures that the effluent water discharged therefrom meets or exceeds current regulations as to the concentration of particulate matter, petroleum hydrocarbons (free oils) and petroleum byproducts in such discharge, and which system also is effective in capturing and thereby limiting particulate matter in the gaseous discharge from the system.

2) Description of the Prior Art

Wet exhausts for diesel engines are well known in the prior art, particularly in marine applications, as marine vessel environments require that the very hot diesel exhaust gases be cooled and water injection into the exhaust stream from the engine is a well known and convenient way of performing such cooling. However most prior art systems to provide such water cooling result in the discharge from the vessel of water which is contaminated with combustion byproducts from the engine, such as petroleum by products, petroleum hydrocarbons, and particulate matter. Before the enactment of regulations controlling the discharge of such materials from vessels, little was done to insure that such contaminants were not discharged. However, the development of a significant body of information on the effect of such contaminants on the environment have shown that petroleum hydrocarbons, especially free oils, tend to attach themselves to suspended particles and sediment, and particulate matter tends to settle into the bottom sediment as well. Since they can stay in the bottom sediment for years, they can be ingested by marine dwelling organisms. High concentrations of contaminants are found in marinas, and it appears that vessels at dockside, while running their diesel power generators and air conditioning equipment, are a significant contributor to such problems. Most marine diesel application installations in use today utilize a separator of one kind or another to remove the water from the exhaust gasses. This water is then discharged overboard along with any contaminants contained therein. A marine engine exhaust system which can remove such contaminants from the exhaust is shown in U.S. Pat. No. 5,980,344 to George F. Widmann, which is assigned to the same assignee as the instant application, and utilizes a first chamber into which the contaminated exhaust is discharged, the surface oils and particulate matters on the surface of the water in this container are then drawn off by a timed vacuum pump to a second container wherein the floating oils and particulate matter is retained and chemically digested to be later disposed. Non-floating contaminants, both oil and particulate, are not removed from the water in the first container and are never further processed by this device. The vacuum pump is not responsive to the water level in the first chamber, but is run by a timer. The water from the second container (which water still contains non floating contaminants) is then pumped to a third container containing filtration devices and the filtered water therefrom discharged overboard. While this device can operate satisfactorily when the vessel is stationary or at below planing speeds, it requires two containers and two steps, a digesting step and a filtering step, to remove the contaminate matter from the exhaust after the contaminated water has been removed from the exhaust in the first chamber, and the first chamber only functions as a separator when the vessel is stationary or moving below planing speeds, for once the vessel is on plane, the exhaust cooling water and the contaminated exhaust gasses are swept directly out of the boat hull through an opening in the bottom of the hull and the water from the exhaust cooling never reaches a level where it can be drawn off to the second or third container.

### SUMMARY OF THE INVENTION

The present invention simplifies the above prior art and provides improved operation by providing a system with a reduced number of structural components and yet one which will not only operate when the vessel is stationary but also, if desired, when operating at any speed, including full speed, and which utilizes the oil in the water to assist the filters in removing particulate matter. To that end, a separating chamber is provided which separates the water and the contaminates from the exhaust. A pump is provided to transport the water from the scrubber to the filter housing wherein the water is filtered and the clean effluent from the filters can be discharged overboard. A measuring and controlling system is provided to measure the level of the water in the scrubber and control the operation of the pump, and an overflow pipe that will dump water from the system in the event of pump failure or if the operator decides to bypass the filtration system in order to conserve filters, such as during passage at open ocean, or at such time that the device is shut down for repairs or service, such as changing filters. By keeping the oil along with the particulate matter in the water until it reaches the filter, the oil aids in the filtration process by assisting in the entrapment of the particulate matter in the filter.

### BRIEF DESCRIPTION OF THE DRAWINGS

FIG. 1 is a front elevational view, partially in section and partially diagrammatic, of a system according to this invention;

FIG. 2 is a plan view of the scrubber of FIG. 1;

FIG. 3 is a side view of the overflow tube of the scrubber of FIG. 1; and

FIG. 4 is a view like FIG. 1 of a system with a different scrubber.

### DETAILED DESCRIPTION OF THE PREFERRED EMBODIMENTS

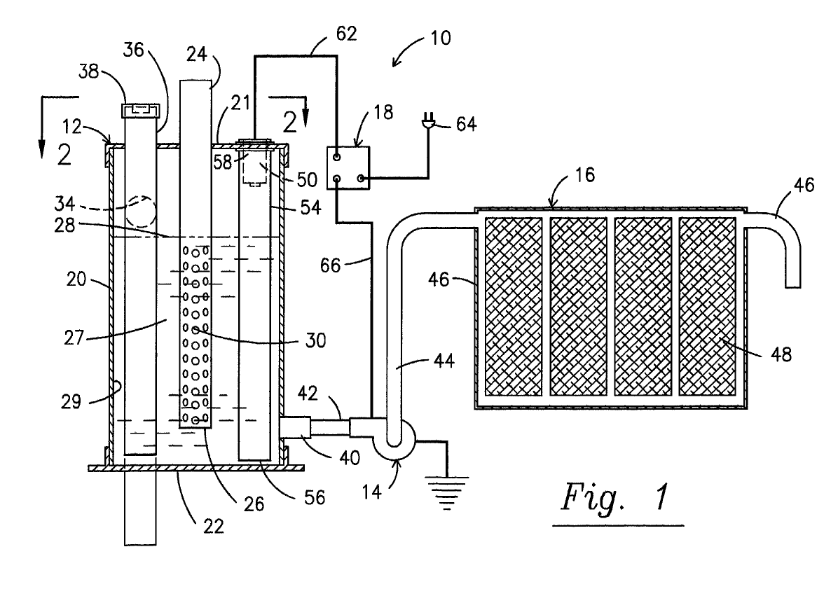

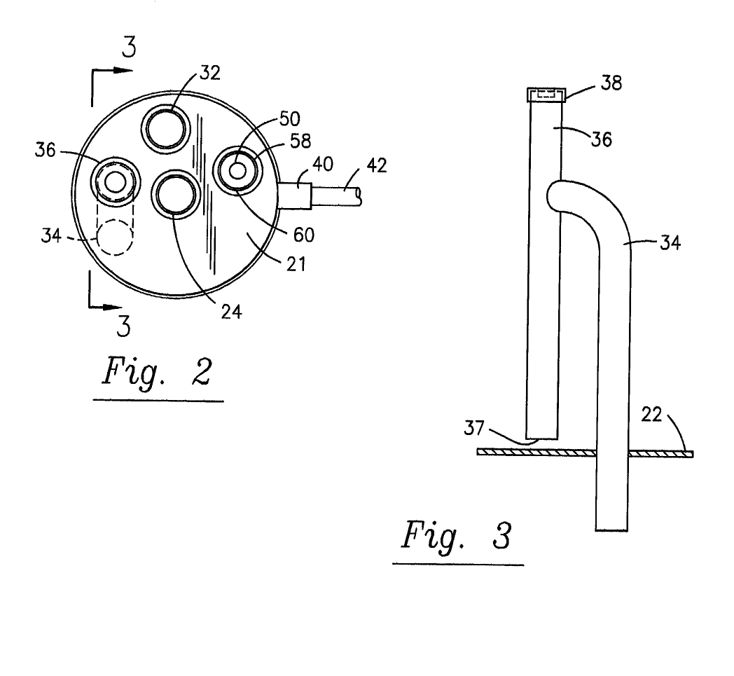

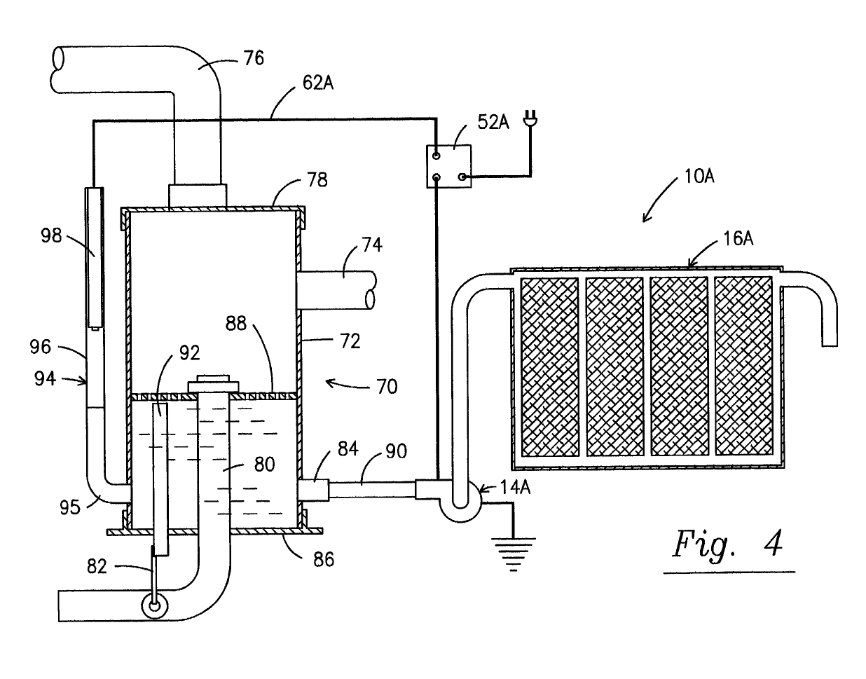

Referring now to the drawings, and more particularly FIGS. 1, 2 and 3, a wet exhaust processing system is shown generally at 10 and includes a separating device in the form of a scrubber 12, a variable speed pump 14, a filter section 16 and a control system 18 for controlling the operation of the pump 14. The scrubber 12 is encased in a cylindrical housing 20 having a top cap 21 and a bottom end cap 22. A wet exhaust pipe from a diesel engine is shown at 24, which pipe enters the scrubber 12 through a central opening in the top cap 2 1, and extends downwardly into the scrubber to terminate in a closed lower end 26. Water 27, with a desired water level 28, is contained in lower portion or sump 29 of the scrubber 12., and the portion of the pipe 24 below the water level 28 is provided with a plurality of exhaust openings 30 spaced both vertically and circumferentially on the pipe 24. Contaminated exhaust enters the scrubber 12 from the pipe 24 through the openings 30 below the level 28 of the water 27 within the scrubber so that the water 27 scrubs the contaminants from the exhaust and the contaminant are disbursed throughout the water. After the “scrubbed” exhaust leaves the water 27, it is passes from the scrubber 12 through an effluent pipe 32 , shown in FIG. 2, which pipe exits the scrubber through the end cap 21.

Two devices control the upper extent of the water level 28 in the sump 29. One such device is an overflow pipe 34, which pipe is confluent with a standpipe 36, which is supported at its upper end in the end cap 21, and has its open lower end 37 displaced slightly above the bottom end cap 22. An air vented end cap 38 is disposed on the top of the standpipe 36, whereby water can enter the standpipe 36 through its open lower end 37 and when the level therein exceeds the level of the overflow pipe 34, the excess will be discharged from the scrubber 12. The second device is the pump 14 with its control system 18.

More particularly, the housing 20 of the scrubber 12 is confluently provided with a nipple 40 which exits the housing 20 slightly above the bottom end cap 22. Confluent with the nipple 40 is a pipe 42 which extends to and supplies the intake of the pump 14, which, in turn, at its output end, is confluently connected to the housing of the filter 16 by a pipe 44. The housing has confluently connected thereto a discharge pipe 46, whereby filtered water can flow and be discharged from the vessel. The pump 14 is sized according to the specifics of the particular vessel application. Information which is collected is water flow in G.P.M. , total length of pipe run, length of all up and down pipes, fittings and turnings in the pipe run, depth of overboard water outlet beneath the vessel's water line, diameter of all nozzles in the pipe run. These are given to the pump supplier that calculates the size pump required to overcome the calculated “head pressure” of the installation based on standard hydraulic engineering calculations for friction loss in pipes and fittings, and still pump the required G.P.M. against maximum pressure of clogged filters. For example, a generator powered by a Cat 3412 engine with a 40 foot pipe run required a model AMPCO ZC2-6.75-30G36BJM-50 pump from Delco Pump with a 7.5 hp 50 Hz motor. The filter housing 16 contains one or more filter elements 48, which elements that have operated satisfactorily in this system can be obtained from Parker Hannifin Corporation under the model name of “Eco-filters”.

The control system 18 includes a water level sensor 50 and a control unit 52 for controlling the operation of the pump 14. A water level sensor which has been found to operate satisfactorily for this invention is a Superox(R) Model SM956A-130600s Ultra Sonic (analogue output) sensor. This sensor 50 is mounted in the top of a “still well”, which is a vertically mounted pipe 54, open at its bottom end 56 and tightly and closely secured at its top end 58 in an opening in the top cap2l of the scrubber 12. The pick-up end of the sensor 50 is directed downwardly, and the still well 54 provides a surface level reading for the water 27 in the scrubber by the sensor 50 which is not disturbed by the violent action of the exhaust gasses within the confines of the scrubber. The mounting between the sensor 50 and the pipe 54 contains a small vent opening 60 so that the level within the still well is not prevented from fluctuating as necessary to indicate the water level within the remainder of the scrubber 12. A control unit 52 which has been found to work satisfactorily is Baldor series 15H Inverter Control unit operated in the Process Operating Mode. Baldor inverters are available from any Baldor dealer worldwide, applicant obtained his from A.A. Electric Corp. in Clearwater, Fla. The output from the sensor 50 is connected to the Baldor control unit 52 by a four conductor cable 62 and the Baldor unit is connected to a source of power 64 which includes 24 volt DC and 340 volt three phase AC. The output from the Baldor unit 52 is connected by a line 66 to the power input of the pump 14 The analogue output from the sensor 50 varies directly proportional to the water level in the still well 54 relative to the adjustable analogue span limits of the sensor. When the water level 28 is close to or at the near span limit but farther than the dead band, the sensor output is 20 mA and the pump 14 should be running at maximum RPM. When the water level sinks to or below the far limit, the output is 4 mA and the pump 14 should not be running. The parameters of the output from the sensor 50 are adjusted so that the water level 28 of the water 27 under normal operating conditions, does not vent through the overflow pipe 34.

While the separating device in the form of the scrubber 12 disclosed above in FIGS. 1-3 was conceived specifically for the system of this invention, the system will work almost as well with modified conventional separator 70 as seen in the exhaust system 10A shown in FIG. 4. The separator 70, which typifies a conventional separator, includes an enclosed container 72 with a wet exhaust gas inlet 74 entering the upper right side thereof An upper exhaust exit to a stack on the vessel is shown at 76 exiting the container 72 from the enclosed top 78 thereof, and a lower exhaust 80, which contains a closing valve 82, exits from the enclosed bottom 86 and extends to and is discharged out the side of the hull above the water line. A nipple 84, confluent with the inside of the container 72 immediately above the enclosed bottom 86, as conventionally installed, was connected directly to an overboard drain, and water from the wet exhaust that did fall out of the exhaust gasses upon entering the separator 70 from the inlet 74, passed through a perforated plate 88, and then out of the separator and overboard through the nipple 84 and the overboard drain (not shown). For the purpose of altering this conventional separator to work in this invention, a pipe 90 was confluently connected to the nipple 84 and from the latter to a pump 14A, which is the same as the pump 14 of the embodiment of FIGS. 1-3.

A second modification was the addition of a standpipe in the form of an overflow pipe 92 to approximately just below the perforated plate 88, for draining the water from the container at such times that the pump 90 was not operational. A third modification was the addition of a still well 94 comprised of an elbow 95 confluent with the inside of the container 72 immediately above the bottom thereof, and an upright pipe 96 extending upwardly from the elbow. A sensor 98 is disposed in the top of the pipe 96, and a cable 62A connects the sensor to a control unit 52A, which in turn is operatively connected to the motor 14A. A filter section 16A is confluently connected to the pump 14A in the same manner as in the embodiment of FIGS. 1-3. While the filter 1 6A operates to cleans the water entering the same from the separator 70 as well as the filter 16 did in the embodiment of FIGS. 1-3, and the water being discharged from this system is now clean as opposed to the water being discharged thereby prior to being so modified, this separator did not function as well in removing contaminant from the exhaust gases. However in retrofit situations where because of structural problems, economic reasons, or no current exhaust gas regulation that the modified separator was unable to meet, the modified separator with the filtration of the water effluent is sufficient to meet water discharge regulations.

While only two embodiments of this invention have been shown and described, it is understood that modifications can be made therein and separators other than those shown above modified without departing from the scope of this invention as claimed.

What is claimed is:

1. A wet exhaust processing system, comprising in combination,
A) an exhaust gas separator having a water receiving and containing portion and including a wet exhaust gas inlet, a separated exhaust gas outlet located above said containing portion, overflow means for limiting the water level within said separator and a water output from said containing portion,
B) a pump having an input confluently connected to said water output of said separator and having an output,
C) means for sensing the level of said water in said separator and for controlling the supply of operating power to said motor,
D) filtration means including a housing containing filtration media and having an input confluently connected to said pump output and an output for discharging filtered water.

2) A system according to claim 1 wherein said means for sensing includes a still well confluently connected to said containing portion and having a water level therein equal to the water level in said containing portion, and a sensor device for sensing the level of water within said still well.

3) A system according to claim 2 wherein said sensor device is spaced from said water level in said still well.

4) A system according to claim 1 wherein said means for sensing the level of said water and for controlling the supply of operating power includes a sensing device and a power control device operatively connected to said motor, and also connected to a source of power and to said sensing device, and being operated by said sensing device to control the supply of power to said motor.

5) A system according to claim 3 wherein said means for sensing the level of said water and for controlling the supply of operating power includes a sensing device and a power control device operatively connected to said motor, and also connected to a source of power and to said sensing device, and being operated by said sensing device to control the supply of power to said motor.

6) A system according to claim 4 wherein said sensing device provides a signal which is directly proportional to the distance between the same and the water level in said still well, whereby the as the distance increases, the signal increases, said power control device is actuated by the signal from said sensor and as the signal increases the power from said control device to said motor increases and said motor runs faster.

6 A system according to claim 1 wherein said wet exhaust inlet is into said containing portion.

7) A system according to 1 wherein said wet exhaust inlet is above said containing portion.

8) A wet exhaust separator including a container, a lower portion of said container being closed to contain water therein and an upper portion thereof being confluent with said lower portion and being above the water in said lower portion, overflow means for limiting the level of water in said containing portion, a wet exhaust line for supplying wet exhaust into said container, an exhaust output line confluently connected to said upper portion, and a water output line confluently connected to said lower portion.

9) A wet exhaust separator according to claim 8 wherein means control the level of water in said container and said wet exhaust line extends below said controlled water level in said lower portion and discharges wet exhaust into said water.

10) A wet exhaust separator according to claim 9 including a filtering device and a pump confluent with said water output line and said filtering device for pumping water from said lower portion to said filter device.

11) A wet separator according to claim 10 including control means responsive to the level of water in said container for controlling the operation of said pump.

12) A wet separator according to claim 11 wherein said control means includes a still well confluent with said lower portion and a sensing means for sensing the level of water in said still well.

13) A wet separator according to claim 13 wherein said control means also includes a power supply for said motor which supplies power to said motor in response to a signal from said sensing means.
